(19) United States
(12) Patent Application Publication
(10) Pub. No.: US 2006/0151380 A1
(43) Pub. Date: Jul. 13, 2006

(54) Filter and method of making same

(76) Inventor: Sim Bunderson, Price, UT (US)

Correspondence Address: TRASK BRITT, P.O. BOX 2550, SALT LAKE CITY, UT, 84110, US

(21) Appl. No.: 11/328,692

(22) Filed: Jan. 10, 2006

Related U.S. Application Data
(60) Provisional application No. 60/643,293, filed on Jan. 12, 2005.

(51) Int. Cl. B01D 35/28

(52) U.S. Cl. 210/450; 210/455; 210/497.01

(57) ABSTRACT

A filter wall and method of making the filter is disclosed. The filter includes a filter wall having at least one layer of filter media. A first end cap is disposed at one end of the filter wall and a second end cap is disposed at a second end of the filter wall. An elongated support extends between the first end cap and the second end cap and is fastened to each, for example, by way of a mechanical fastener. In one embodiment, the mechanical fastener may include a rivet. The filter is devoid of adhesive material and avoids the penetration of the filter media by the mechanical fasteners. The use of mechanical fasteners enables the filter to be used in high temperature environments without concern for failure due to degradation of adhesive materials. Additionally, the use of mechanical fasteners enables the simple and efficient refurbishment and reconditioning of a filter after the filter media has become sufficiently spent.

### CROSS-REFERENCE TO RELATED APPLICATION

This application claims the benefit of U.S. Provisional Application No. 60/643,293, filed Jan. 12, 2005.

### BACKGROUND OF THE INVENTION

1. Field of the Invention

The present invention is generally related to filtration apparatuses and, more particularly, to filtration structures or apparatuses used to filter particulates or other matter from a fluid stream and which are capable of withstanding elevated temperatures without failure or substantial degradation of the filtration structure.

2. State of the Art

Filtration apparatuses, referred to herein generally as filters, are utilized in numerous environments and processes. Generally, filters are utilized to separate two or more components from one another as a mixture of such components is passed through the filter. For example, filters are often used to separate or remove particulates from a fluid stream, the fluid being either a liquid or a gas. Removal of the particulates may be to harvest the particulate matter from the fluid stream for further processing, to provide a more purified fluid stream, or for both purposes. In one example, particulates may be filtered from a stream of water for purification purposes of the water. In another example, minerals may be filtered out of a slurry for further processing and refinement.

Similarly, particulates may be removed from a gaseous stream for purification of the gas. The gas may, for example, be used in a combustion process wherein it is desirable to eliminate particulate matter prior to the combustion process because presence of such particulates might be harmful to the combustion apparatus or otherwise reduce the efficiency of the combustion process. In another example, a gaseous stream produced by a combustion process may be filtered to remove particulates that are potentially dangerous to the surrounding environs, including the air being breathed by individuals in a location where the combustion gas is being exhausted.

In many industrial environments, filtering of the exhaust gas produced by machinery and equipment is required and is heavily regulated by government institutions. For example, the Mine Health and Safety Administration (MSHA) and the National Institute for Occupational Safety and Health (NIOSH) impose various regulations on the type of emissions that are allowed in various environments including underground mining operations. Such exhaust may include, for example, that of diesel equipment. In one particular example, diesel equipment utilized in underground mining operations is heavily regulated regarding exhaust emissions and, particularly, regarding the emission of diesel particulate matter (DPM).

Referring to FIGS. 1 and 2, a prior art filter 100 is shown which is used to filter diesel particulate matter from an exhaust stream of diesel powered equipment. The filter 100 is shaped generally as a cylindrical or annular member. Generally, the filter 100 may be positioned so that a fluid (exhaust) stream passes into the center area 102 and is forced through a filter wall 104 of the filter, which wall contains a filter media. Of course the fluid stream path could be in the reverse direction such that the fluid travels through the filter wall 104 into the center area 102. After passing through the filter wall 104 and its associated filter media, the filtered fluid stream may be exhausted from the associated system or it may be further filtered or processed depending on the specific application and associated regulations or other requirements.

The filter 100 is constructed from a number of individual components. For example, the filter 100 includes a first end cap 106 and a second end cap 108 that are coupled to respective ends of the filter wall 104. The filter wall 104 contains one or more layers of filter media 110 (FIG. 2) through which the fluid stream is passed. As a part of the filter wall, the filter media 110 may be contained and supported by an inner radial support 112 and an outer radial support 114 which may comprise, for example, mesh or screen. The radial supports 112 and 114 are generally configured to support the filter media 110 while still allowing a fluid stream to pass therethrough.

The end caps 106 and 108 are generally configured as annular, cup-like structures covering the longitudinal end portions of the filter media 110 and associated supports 112 and 114. The end caps 106 and 108 are maintained in place relative to the filter media 110 and the supports 112 and 114 by means of an adhesive material 116.

A filter 100, constructed as described with respect to FIGS. 1 and 2, should generally provide satisfactory filtering performance assuming that the temperature of the environment in which the filter 100 is placed is not elevated to a level that results in degradation and failure of the adhesive 116. Unfortunately, many applications or environments in which such filters 100 are required expose the filter 100 to temperatures beyond the performance limit of available adhesive materials. One such application includes the use of filters in what is known as “nonpermissible” equipment.

In accordance with United States Government standards, mobile, diesel-powered equipment may be classified as “permissible” or “nonpermissible.” The “permissible” classification indicates that the equipment is authorized for service in various environments and applications including various underground mining applications. In order to be classified as “permissible” equipment, certain criteria set forth in 30 Code of Federal Regulations (CFR) Part 36 must be met. While 30 CFR Part 36 provides various technical requirements that define whether a mobile diesel powered machine is to be classified as “permissible” or not, one requirement is that permissible equipment or machines cool the diesel exhaust before releasing it into the atmosphere. Specifically, 30 CFR § 36.25(c) states that permissible equipment must include an exhaust cooling system capable of reducing the temperature of the undiluted exhaust gas to less than 170° F. at the point of discharge from the cooling system.

Nonpermissible equipment, one the other hand, is not required to have its exhaust cooled. The practical effect is that a filter configured to operate in equipment classified as being permissible, such as a filter 100 utilizing an adhesive material 112, will likely be inappropriate for use in equipment that is “nonpermissible” due to the elevated temperatures to which the filter will likely be exposed. At best, a filter utilizing adhesive materials will fail at a faster rate when placed in an environment with an elevated temperature and, therefore, require more frequent replacement when used in nonpermissible equipment.

While filters have recently been produced using “ceramic” type adhesives which provide for exposure to relatively higher temperatures for relatively longer periods of time, such adhesives are more expensive and are still prone to temperature-induced failure. Additionally, even with higher temperature adhesives, an operator of both permissible and nonpermissible equipment will either have to purchase, stock and maintain multiple types of filters (i.e., one type for permissible equipment and another type for nonpermissible equipment) or will have to buy all of its filters with high-temperature adhesive so as to enable the filters to be compatible with both types of equipment.

One attempt to produce filters without adhesive materials includes that which is disclosed by U.S. Patent Publication No. US 2004/0154977 A1 (hereinafter the “Wells publication”). This publication discloses a filter which avoids the use of “potting compounds” in assembling the filter and, instead, secures the end caps to the filter material by use of mechanical fasteners. However, the fastening of the ends caps directly to the filter material by penetration of the filter material with a mechanical fastener results in a potential fluid stream bypass path which will allow an amount of fluid to pass therethrough without being filtered. In other words, penetration of the filter media by a mechanical fastener creates the extreme likelihood that an opening will be formed through which fluid may travel instead of having to pass directly through the fluid media for removal of particulates or other matter. In essence, penetration of the filter media results in the creation of a “short circuit” in the fluid path relative to the filter media allowing a portion of the fluid to bypass the filtering process.

In view of the shortcomings in the art, it would be advantageous to provide a filter and method of manufacturing such a filter that enables the use of the filter in high temperature environments, such as with so-called impermissible equipment, without the limitations imposed by adhesive materials and without undesired penetration of the filter media. Additionally, it would be advantageous to provide a filter which is relatively inexpensive to construct such that a single style filter may be stocked and utilized regardless of whether it is expected to be used in high temperature or relatively low temperature applications. It would further be advantageous to provide a method of manufacturing such a filter and a method of refurbishing and reconditioning such a filter.

### BRIEF SUMMARY OF THE INVENTION

In accordance with one aspect of the invention a filter is provided. The filter comprises a filter wall comprising at least one layer of filter media. A first end cap is disposed at a first end of the filter wall and a second end cap is disposed at a second end of the filter wall. At least one elongated support is positioned to extend between the first end cap and the second end cap. A first mechanical fastener couples a first end of the at least one elongated support to the first end cap, and a second mechanical fastener couples a second end of the at least one elongated support to the second end cap. The filter wall may be configured as a cylindrical or annular filter wall and may include a material such as fiberglass for the filter media. The filter may include additional components such as, for example, support structures in association with the filter media.

In accordance with another embodiment of the invention, a method of manufacturing a filter is provided. The method includes providing a filter wall having at least one layer of filter media. A first end cap is disposed at a first end of the filter wall and a second end cap is disposed at a second end of the filter wall. At least one elongated support is disposed between the first end cap and the second end cap and is mechanically fastened to the first end cap and the second end cap.

In accordance with yet another embodiment of the present invention, another method of manufacturing a filter is provided. The method includes providing a filter wall having at least one layer of filter media, providing a first end cap and a second end cap, and coupling the first end cap to a first longitudinal end of the filter wall and coupling the second end cap to a second longitudinal end of the filter wall without the use of adhesives and without penetration of the at least one layer of filter media.

In accordance with yet a further aspect of the present invention, a method of refurbishing a filter is provided. The filter being refurbished includes a filter wall with at least one layer of filter media, a first end cap disposed at a first end of the filter wall, a second end cap disposed at a second end of the filter wall, an elongated support extending between the first end cap and second end cap, and at least one mechanical fastener connecting the elongated support and the first end cap. The method of refurbishing the filter comprises removing the at least one mechanical fastener, removing the first end cap and replacing the at least one layer of filter media with at least one other layer of filter media. The first end cap is repositioned at the first end of the filter wall and the elongated support is mechanically refastened to the first end cap.

In accordance with yet another aspect of the present invention, a filtration system is provided. The filtration system includes equipment including a fluid source configured to produce a fluid stream. A flow path, including a housing, is coupled with the fluid source. A filter is disposed in the housing. The filter may comprising a filter wall comprising at least one layer of filter media, a first end cap disposed over a first longitudinal end of the filter wall, a second end cap disposed over a second longitudinal end of the filter wall, at least one elongated support extending between the first end cap and the second end cap, a first mechanical fastener coupling a first end of the at least one elongated support to the first end cap, and a second mechanical fastener coupling a second end of the at least one elongated support to the second end cap. The flow path is configured to direct the fluid to the filter, through the filter wall and out an exit formed in the housing.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is perspective view of a prior art filter;

FIG. 2 is partial cross-sectional view of the filter shown in FIG. 1;

FIG. 3 is a perspective view of a filter in accordance with one embodiment of the present invention;

FIG. 4 is a side plan view of the filter shown in FIG. 3;

FIG. 5 is a cross-sectional view of the filter shown in FIG. 3;

FIG. 6 is a partial cross-sectional view of the filter shown in FIG. 3; and

FIG. 7 is a schematic of a system including a filter in accordance with an embodiment of the present invention.

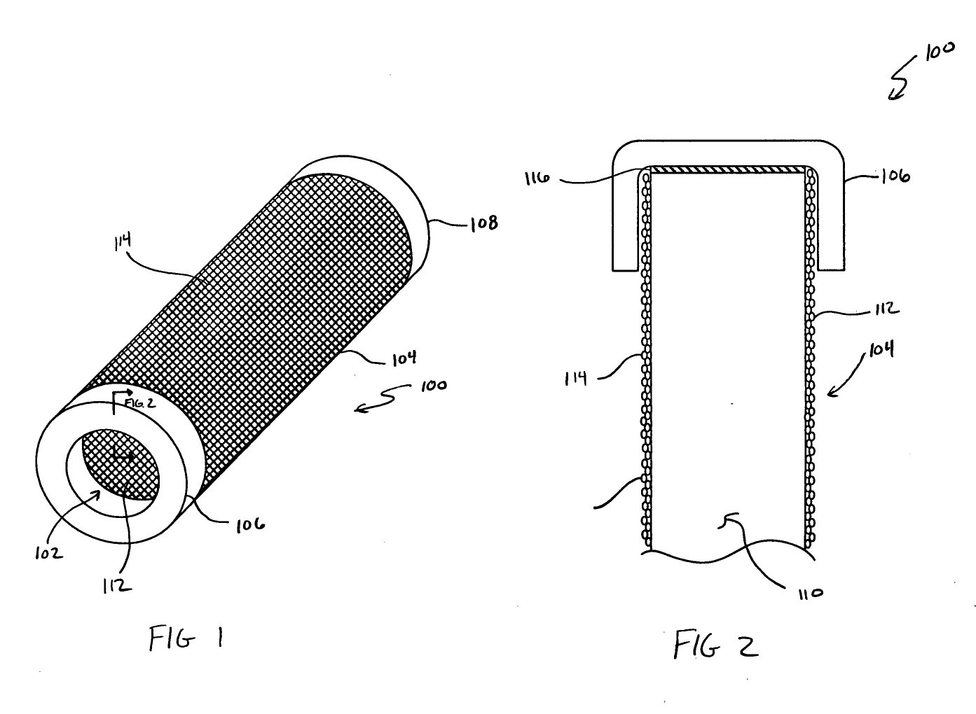

### DETAILED DESCRIPTION OF THE INVENTION

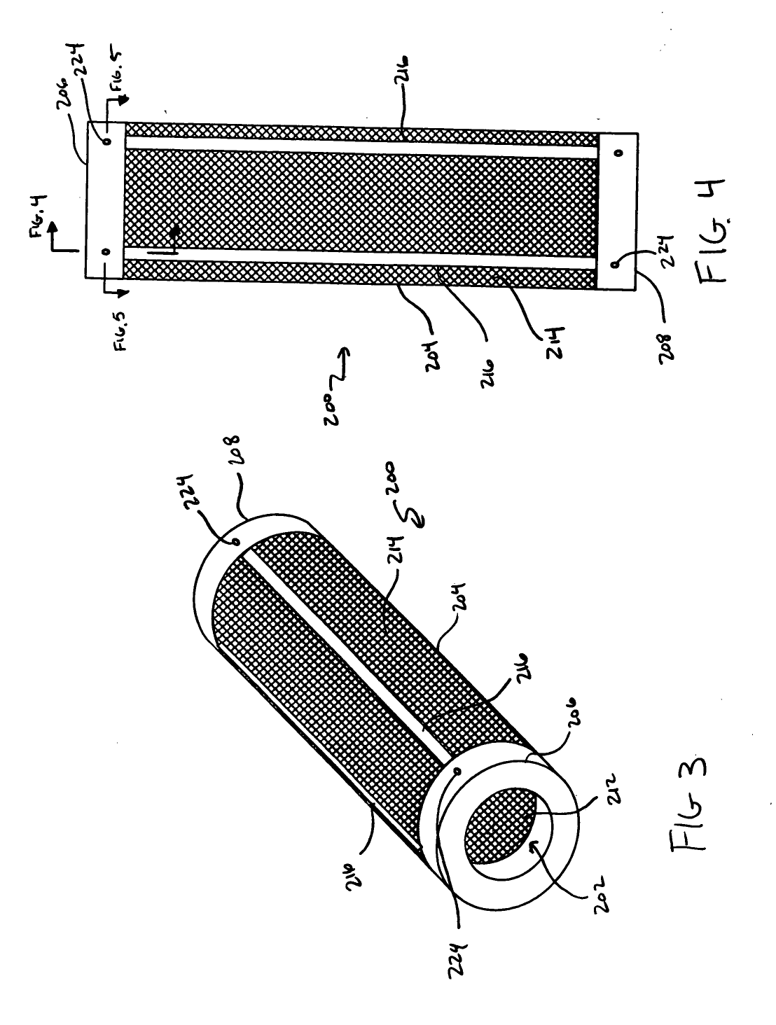

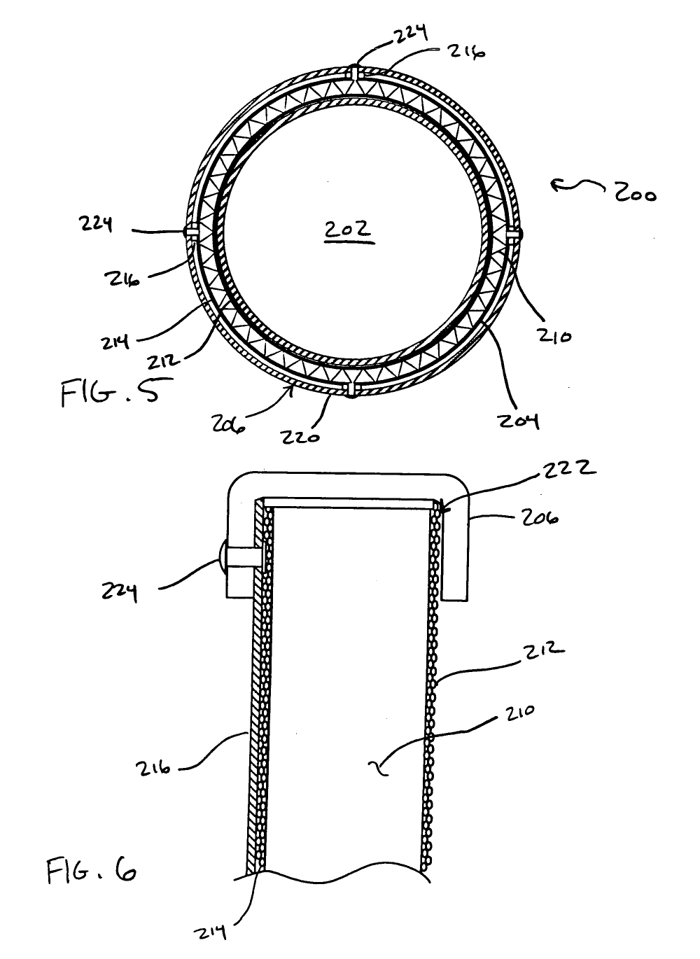

Referring to FIGS. 3 and 4, a filter 200 is shown that may be used, for example, in filtering particulates or other matter from a fluid stream. The filter 200 is configured as a generally cylindrical or annular shaped structure. Depending on the application and on the specific type of equipment in which the filter is installed, a fluid stream, such as an exhaust stream from a diesel or other combustion type engine, may be directed into the center volume 202 of the filter and then directed through the filter wall 204 of the filter 200 (which defines the center volume 202 or area). The filter wall 204 contains a filter media as shall be discussed in further detail below.

As the fluid stream passes through the filter media of the filter wall 204, particulates of a specified type or size may be captured by the filter media to remove them from the gas stream. The filtered gas stream may then be exhausted or further filtered or processed depending on the specific application and environment. Of course, a fluid stream may be directed in the reverse direction such that it passes through the filter wall 204 into the center area 202 of the filter 200 and then subsequently exhausted. The fluid flow path may depend, for example, on the specific equipment or environment in which the filter 200 is disposed.

It is noted that the filter wall 204, while depicted as being cylindrical or annular, may exhibit other geometries and configurations. For example, the filter wall 204 may be constructed as a flat panel wherein a fluid flow path simply traverses the filter wall from a first side thereof to a second side thereof. Additionally, rather than cylindrical, the filter wall 204 may exhibit geometries, such as a polygonal cross-sectional geometry, as taken substantially transverse to its longitudinal axis, and may or may not exhibit an enclosed or circumscribed geometry.

The filter 200 is formed of a number of individual components, including a pair of end caps 206 and 208 which are disposed at the longitudinal ends of the filter wall 204. In one embodiment, the end caps 206 and 208 may be configured to substantially cover the longitudinal ends of the filter wall 204 such as seen in FIG. 6.

As seen in FIGS. 5 and 6, the filter wall 204 is constructed of a number of components including one or more layers of filter media 210. The filter media 210 may be formed from a number of different materials depending, for example, the type of fluid stream anticipated to flow therethrough as well as the type of particulates or other material being filtered from the fluid stream. In one particular embodiment, the filter media 210 may comprise a fiber glass material formed generally as a sheet. As shown in FIG. 5, the filter material may be configured in the form of what is known as a pleated pack. The use of a pleated pack provides a structure which increases the surface area of the exposed filter media 210. While not expressly shown in the drawings, a light gauge mesh or wire screen may be disposed on one or both sides of the filter media 210 and be conformal therewith such that it too exhibits a pleated configuration to provide a measure of structural support to the filter media 210.

Additionally, the filter media 210 may be disposed between a first support structure 212, located radially inwardly of the filter media 210, and a second support structure 214 that is disposed radially outwardly of the filter media 210. The support structures 212 and 214 are configured to allow passage of a fluid stream therethrough and may be formed, for example, of a screen or mesh material that is generally a heavier gauge material than the conformal mesh or screen discussed hereinabove. In one exemplary embodiment, the support structures 212 and 214 may be formed of expanded metal. The support structures 212 and 214 serve to structurally support and contain the filter media 210 disposed therebetween.

Still referring to FIGS. 3 and 4, a plurality of elongated supports 216 are disposed adjacent the cylindrical wall 202 and extends between the end caps 206 and 208. The elongated supports 216 are coupled with the end caps 206 and 208 so as to couple the various components (e.g., support structures 212 and 214, filter media 210, and end caps 206 and 208) together as a unified structure. As shown in FIGS. 5 and 6, the elongated support structures 216 may be placed adjacent the second support structure 214 and positioned such that the radially outer wall 220 of an end cap 206 covers or conceals the longitudinal end 222 of a given elongated support 216.

It is noted that the presently disclosed embodiment shows the elongated supports 216 located only adjacent the second support structure 214 (i.e., along the outer radial side of the filter wall 204). However, in other embodiments, the elongated supports may be located adjacent the first support structure 212 (i.e., along the inner radial side of the filter wall 204) or adjacent both support structures 212 and 214. When the filter wall 204 is cylindrically configured, or exhibits another circumscribing geometry, placement of the elongated supports 216 only adjacent the radially outer side of the filter wall 204 provides adequate support to couple the filter 200 together while greatly simplifying the assembly and manufacture of the filter 200.

In one embodiment, the elongated support 216 may be fastened to the radial outer wall 220 of the end cap by way of a mechanical fastener 224. In one particular example, the mechanical fastener may be in the form of a rivet. Use of a rivet to fasten the end caps 206 and 208 with the elongated supports 216 enables simple and efficient assembly and manufacture of the filter 200. It is specifically noted that the mechanical fastener 224 does not penetrate the filter media 210, although it may or may not be coupled with a support structure 214.

In other embodiments of the present invention, the mechanical fastener 224 may include a screw or some other threaded fastener. In yet other embodiments of the invention, the elongated support members may be joined to the end cap by means of a spot weld or by brazing. However, such thermomechanical means of joining may not provide the same advantages in the assembly and construction of the filter 200 and, further, may not provide the same reliability as a strictly mechanical means of fastening when the filter is intended to be placed in high temperature environments.

Referring more specifically to FIG. 6, in one embodiment, an end layer of filter media 226 is disposed between an end cap 206 and the cylindrical wall 202 to prevent particulates from flowing through such a path without being properly filtered. The end layer of filter media 226 may be stapled or otherwise fixed to the end cap 206. In another embodiment the end layer of filter material may be held in place by compression effected between the end cap and the cylindrical wall 202. In either case, the elongated supports 216 may be used to help control the amount of compression between the end caps 206 and 208 and the cylindrical wall 202.

For example, the elongated supports 216 may be configured to exhibit a predetermined length relative to a length of the cylindrical wall 202 to provide an abutment against which the end caps 206 and 208 may bear. In other words, the difference in length exhibited by the elongated supports 216 as compared to the cylindrical wall 202 may be used to control the amount of compression experienced by the end layer of filter media 226 when the end caps 206 and 208 are assembled on to the filter 200 and fixed to the elongated supports 216.

It may be desirable to control the amount of compression experienced by the end layer of filter media 226, for example, to prevent the ends of the support structures 212 and 214 from cutting the filter media 226 and thereby provide an unfiltered flow path for any fluid being passed through the filter 200.

The elongated supports 216, therefore, may be configured as members that experience tension between the end caps 206 and 208, such as a guy or a stay, they may be configured to act in compression, such as a columnar member, or they may be configured to provide support in both tension and compression.

The configuration of the filter 200 provides various advantages over prior art filters that are constructed using an adhesive to bond the end caps to, for example, the cylindrical wall of the filter. As previously discussed, a filter utilizing adhesive is subject to thermal degradation and failure when the adhesive is exposed to elevated temperatures, such as when they are installed in impermissible equipment. The filter 200 of the present invention does not rely on adhesive materials to join any of its components and, therefore, is substantially more reliable than adhesively joined filters in high temperature environments. Similarly, in certain applications where the filter is exposed to corrosive or caustic environments, an adhesive may be adversely affected while the mechanically joined filter 200 of the present invention provides improved reliability and more predictable performance.

To further enhance the reliability and performance of the filter 200, various components may be constructed of materials capable of withstanding high temperatures, corrosive environments, or both. In one embodiment, the end caps 206 and 208, the support structures 212 and 214, and the elongated supports 216 may be formed of a material comprising, for example, steel, stainless steel, other metals or metal alloys, or combinations of such materials.

It is further noted that the configuration of the filter 200 of the present invention enables simple recycling, refurbishing and reconditioning thereof. For example, after the filter media 210 of a given filter has captured a significant amount of particulates or other filtered matter, it becomes “clogged” or “plugged” such that the flow rate of fluid that may pass through the filter media is sufficiently reduced. Thus, with the configuration of the present invention, the mechanical fasteners 224 may be removed and the filter 200 disassembled. The old filter media 214 may be replaced by new filter media and the filter 200 may be reassembled, again using mechanical fasteners 224 (which mechanical fasteners may the same as those removed or they may be new mechanical fasteners replacing the old ones). Prior art filters utilizing adhesive materials do not accommodate the refurbishing and reconditioning of used filters with such simplicity and efficiency.

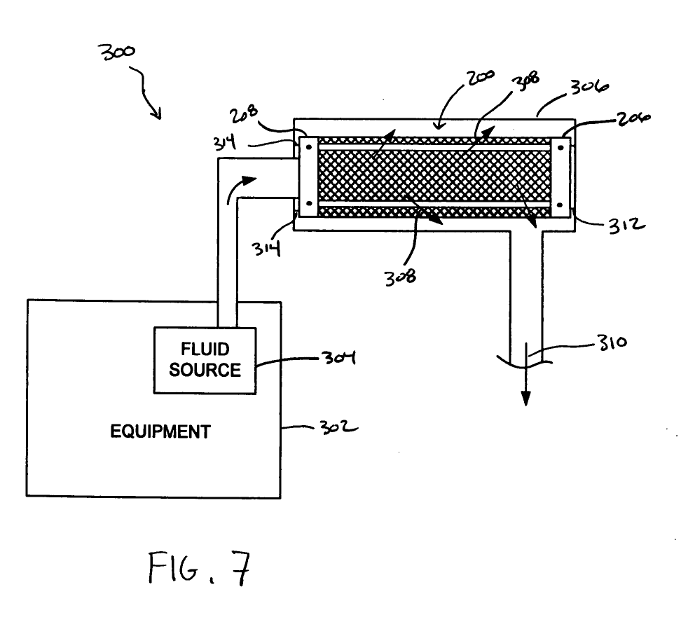

Referring now to FIG. 7, a system 300 is shown in which a filter 200 constructed in accordance with an embodiment of the present invention is utilized. The system includes equipment 302 that produces a fluid stream from a fluid source 304. For example, the equipment 302 may include stationary or mobile equipment having a combustion engine wherein the exhaust of the combustion engine is the fluid source 304. Various examples of such equipment may include underground mining equipment such as scoops and shield haulers and other related equipment, although the present invention is not limited to such equipment.

The fluid source 304 produces fluid which passes to the filter 200 which is disposed in a an associated housing 306. The fluid is passed to the center volume 202 (FIG. 3) of the filter 200 and through the filter wall 204 (FIGS. 3 through 6) such as previously discussed and as indicated by directional arrows 308. The filtered fluid (i.e., the fluid that has passed through the filter wall 204) may then be directed from the housing 306 as indicated by directional arrow 310 and exhausted to atmosphere or it may be additionally filtered or processed as desired.

It is noted that additional layers of filter media 312 and 314 may be strategically placed between the filter 200 and housing 306, such as adjacent the end caps 206 and 208, such that any potential fluid path other than that through the filter wall 204 still provides filtering of the fluid stream. Thus, if fluid were to attempt to bypass the filter wall 204 and travel between the end caps 206 and 208 and the adjacent surfaces of the housing 306, the fluid would still pass through one or more layers of filter media 312 and 314 to capture particulates or other matter.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A filter comprising:
a filter wall comprising at least one layer of filter media;
a first end cap disposed at a first end of the filter wall;
a second end cap disposed at a second end of the filter wall;
at least one elongated support extending between the first end cap and the second end cap;
a first mechanical fastener coupling a first end of the at least one elongated support to the first end cap; and
a second mechanical fastener coupling a second end of the at least one elongated support to the second end cap.

2. The filter of claim 1, wherein the filter wall is configured as a cylindrical filter wall.

3. The filter of claim 2, wherein the filter wall further comprises at least one support structure adjacent the at least one layer of filter media.

4. The filter of claim 3, wherein the at least one support structure includes a radial inner support structure and a radial outer support structure.

5. The filter of claim 3, wherein the filter media includes a material comprising fiberglass.

6. A method of manufacturing a filter, the method comprising:
providing a filter wall having at least one layer of filter media;
disposing a first end cap at a first end of the filter wall;
disposing a second end cap at a second end of the filter wall;
disposing at least one elongated support between the first end cap and the second end cap; and
mechanically fastening the elongated support to the first end cap and the second end cap.

7. The method according to claim 6, wherein providing a filter wall further comprises providing at least one support structure adjacent the at least one layer of filter media.

8. A method of manufacturing a filter, the method comprising:
providing a filter wall having at least one layer of filter media;
providing a first end cap and a second end cap; and
coupling the first end cap to a first longitudinal end of the filter wall and coupling the second end cap to a second longitudinal end of the filter wall without the use of adhesives and without penetration of the at least one layer of filter media.

9. A method of refurbishing a used filter having a filter wall with at least one layer of filter media, a first end cap disposed at a first end of the filter wall, a second end cap disposed at a second end of the filter wall, an elongated support extending between the first end cap and second end cap, and at least one mechanical fastener connecting the elongated support and the first end cap, the method comprising:
removing the at least one mechanical fastener;
removing the first end cap;
replacing the at least one layer of filter media with at least one other layer of filter media;
repositioning the first end cap at the first end of the filter wall; and
mechanically refastening the elongated support and the first end cap.

10. A filtration system comprising:
equipment including a fluid source configured to produce a fluid stream;
a flow path coupled with the fluid source including a housing;
a filter disposed in the housing, the filter comprising:
a filter wall comprising at least one layer of filter media;
a first end cap disposed over a first longitudinal end of the filter wall;
a second end cap disposed over a second longitudinal end of the filter wall;
at least one elongated support extending between the first end cap and the second end cap;
a first mechanical fastener coupling a first end of the at least one elongated support to the first end cap; and
a second mechanical fastener coupling a second end of the at least one elongated support to the second end cap;
wherein the flow path is configured to direct the fluid to the filter, through the filter wall and out an exit formed in the housing.
